(19) United States
(12) Patent Application Publication
(10) Pub. No.: US 2026/0295777 A1
(43) Pub. Date: Oct. 1, 2026

(54) DUAL MODE FIELD DEVICE MOUNT

(71) Applicant: Rosemount Inc., Shakopee, MN (US)

(72) Inventors: Jeffrey A COTA, Rosemount, MN (US); Emma R PARRY, Bloomington, MN (US); Sydney JJ HOLCOMB, Minneapolis, MN (US); Kyle S WARREN, Prior Lake, MN (US); Jacob D HOLM, Shakopee, MN (US); Samuel V HAARALA, Chaska, MN (US); Nathan S LOYA, Cologne, MN (US)

(21) Appl. No.: 19/092,298

(22) Filed: Mar. 27, 2025

(51) Int. Cl. B25B 5/14; B25B 5/10; B25B 5/16; F16M 13/02

(52) U.S. Cl. CPC B25B 5/147; B25B 5/102; B25B 5/16; F16M 13/022

(57) ABSTRACT

A field device mount is configured to couple to a field device and includes a union, a dual-mode clamping foot, at least one bolt, and a pair of fasteners. The dual-mode clamping foot is configured to engage a process fluid conduit. The dual-mode clamping foot is coupled to the union and has a plurality of apertures therethrough. The dual-mode clamping foot is configured to engage a larger diameter process fluid conduit in a first mode and is configured to engage a smaller diameter process fluid conduit in a second mode. A dual-mode clamping foot is also provided.

### BACKGROUND

In industrial settings, control systems are used to monitor and control inventories of industrial and chemical processes, and the like. Typically, the control system performs these functions using field devices distributed at key locations in the industrial process and coupled to the control circuitry in the control room by a process control loop. The term “field device” refers to any device that performs a function in a distributed control or process monitoring system, including all devices used in the measurement, control and monitoring of industrial processes.

Field devices are used by the process control and measurement industry for a variety of purposes. Usually, such devices have a field-hardened enclosure so that they can be installed outdoors in relatively rugged environments and are able to withstand climatological extremes of temperature, humidity, vibration, mechanical shock, et cetera. These devices also can typically operate on relatively low power. For example, field devices are currently available that receive all of their operating power from a known 4-20 mA loop.

There are a number of different types of field devices. Such devices include process variable transmitters that include or are coupled to a process variable sensor and provide an indication of the process variable to the control system. Field devices also include actuators, such as valve controllers and positioners that are able to generate a physical output (i.e., position of a member) based on a signal received from the control system. Field devices also include gauges or displays that may be mounted at key locations in the process environment to indicate process variables or conditions. Field devices also include sensor assemblies mounted to process piping, tanks, or vessels, herein referred to as fluid handling equipment, and electrically coupled to process variable transmitters.

Field devices are often mounted to the process installation (e.g., process pipes) to which they are coupled. Such mounting presents some challenges as the fluid handling equipment (pipes or vessels) may experience a wide variation in temperature as well as mechanical vibration. However, a field device mount needs to robustly maintain its mounting location even under such conditions.

### SUMMARY

A field device mount is configured to couple to a field device and includes a union, a dual-mode clamping foot, at least one bolt, and a pair of fasteners. The dual-mode clamping foot is configured to engage a process fluid conduit. The dual-mode clamping foot is coupled to the union and has a plurality of apertures therethrough. The dual-mode clamping foot is configured to engage a larger diameter process fluid conduit in a first mode and is configured to engage a smaller diameter process fluid conduit in a second mode. A dual-mode clamping foot is also provided.

### BRIEF DESCRIPTION OF THE DRAWINGS

FIG. 1 is a chart of required field device mount clamping force as a function of pipe diameter.

FIG. 2 is a diagrammatic view of a field device mount as set forth in the published application for smaller pipe diameters.

FIGS. 3 and 4 are top plan and front elevation views, respectively, of a clamping foot.

FIGS. 5 and 6 are top plan and front elevation views, respectively, of a clamping foot for smaller pipe diameters in accordance with an embodiment of the present invention.

FIG. 7 is a perspective view of a bottom surface of a dual-mode clamping foot in accordance with an embodiment of the present invention.

FIG. 8 is a diagrammatic view of a field device mount utilizing a dual-mode clamping foot in a first mode in accordance with an embodiment of the present invention.

FIG. 9 is a diagrammatic view of a field device mount utilizing a dual-mode clamping foot in a second mode in accordance with an embodiment of the present invention.

### DETAILED DESCRIPTION OF ILLUSTRATIVE EMBODIMENTS

In recent years, the use of surface-mounted (i.e., mounted to an external surface of fluid handling equipment, such as a pipe or vessel) temperature measurement devices have become a popular alternative to direct temperature measurement methods (e.g., traditional thermowell). These surface-mounted devices can provide a non-intrusive measurement point which measures the external temperature of the pipe or vessel surface. Recently, improvements in field device mounting techniques have been proposed as set forth in U.S. Published Patent Application 2024/0229837 A9, which application is incorporated herein by reference. In the published application, a number of techniques are described including using one or more band and tensioner devices to mount a field device to a process fluid conduit such as a pipe. For applications that use pipes having smaller diameters, defined herein as 2-inch diameter or smaller, the published application employs a v-bolt in combination with a bracket. Embodiments described herein generally provide improvements upon the system described in the published application for smaller diameters process fluid conduits.

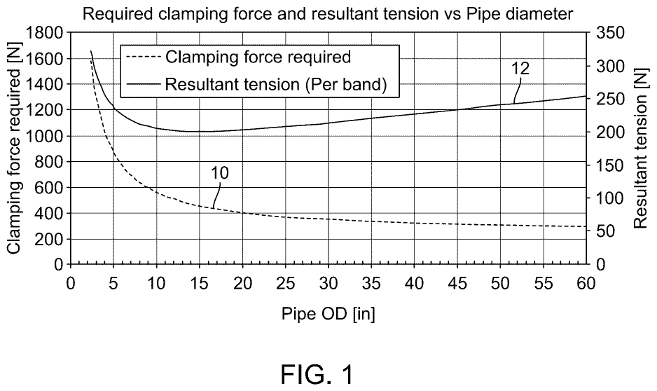

FIG. 1 is a chart of required field device mount clamping force as a function of pipe diameter. As can be seen, the chart shows clamping force indicated at reference numeral 10 and resultant tension per band at reference numeral 12 in newtons (N) for pipe diameters ranging from 0 inches to 60 inches. The amount of clamping force and resultant tension per band increases dramatically at pipe diameters below 2 inches. Additionally, practically installing and tensioning a band on a pipe size below 2 inches is difficult, if not impossible as non-uniform tension can cause misalignment of the tensioner plate. Thus, bands may not be effectively used for such applications. For such smaller pipe diameters, the published application describes using a v-bolt, fasteners, and a perpendicular plate.

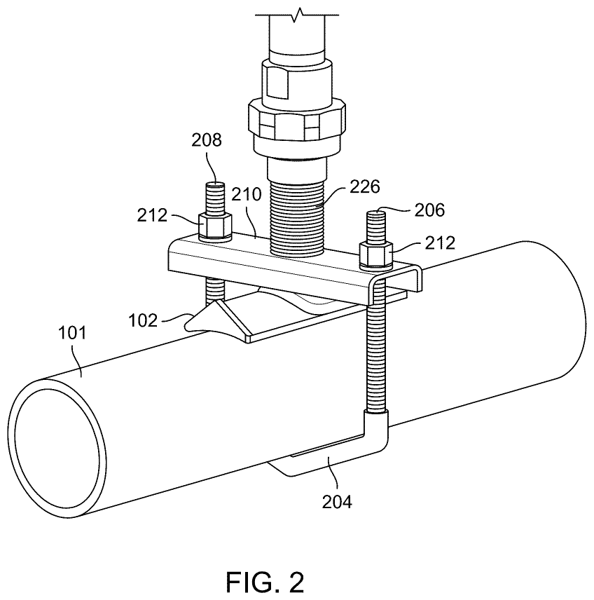

FIG. 2 is a diagrammatic view of a field device mount as set forth in the published application for smaller pipe diameters. For relatively smaller diameter pipe sizes, a clamping foot 102 is urged against fluid handling equipment 101 (e.g., pipe) by v-bolt clamp 204. As shown, v-bolt clamp 204 generally has a “v” shape and a pair of threaded ends 206, 208 which pass through apertures of beam 210. Fasteners, such as nuts 212 are threaded upon ends 206, 208 in order to generate significant clamping force between clamping foot 102 and fluid handling equipment 101.

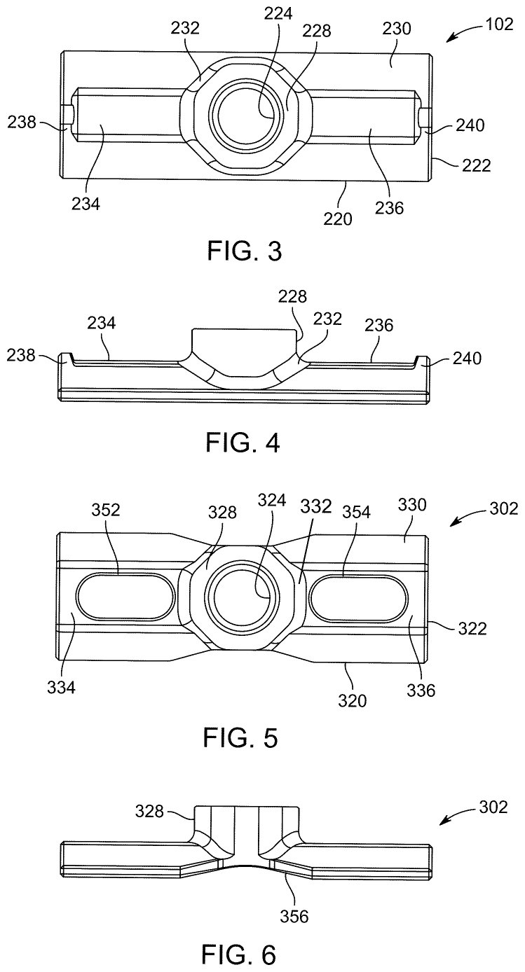

FIGS. 3 and 4 are top plan and front elevation views, respectively, of clamping foot 102 shown in FIG. 2. Clamping foot 102 is generally rectangularly shaped having first side 220 that is longer than a second side 222. The longer side 220 is generally aligned with an axis of a process fluid conduit, as shown in FIG. 2. Clamping foot 102 also includes an internally threaded central aperture 224 that is configured to receive a union (shown as reference numeral 226 in FIG. 2) that couples to a field device such as a temperature sensor/transmitter. Central aperture 224 is surrounded by a sidewall 228 that is shaped as a rounded-off hexagon. The hexagonal shape is helpful in that it allows a wrench to grasp the clamping foot when the union 226 and/or field device are being threaded thereto. Sidewall 228 is coupled to foot body 230 at interface 232. In one example, interface 232 is a weld. Clamping foot 102 also includes a pair of reinforcing ribs 234, 236 that extend from sidewall 228 along then length of foot body 230 to reinforced ends 238, 240, respectively.

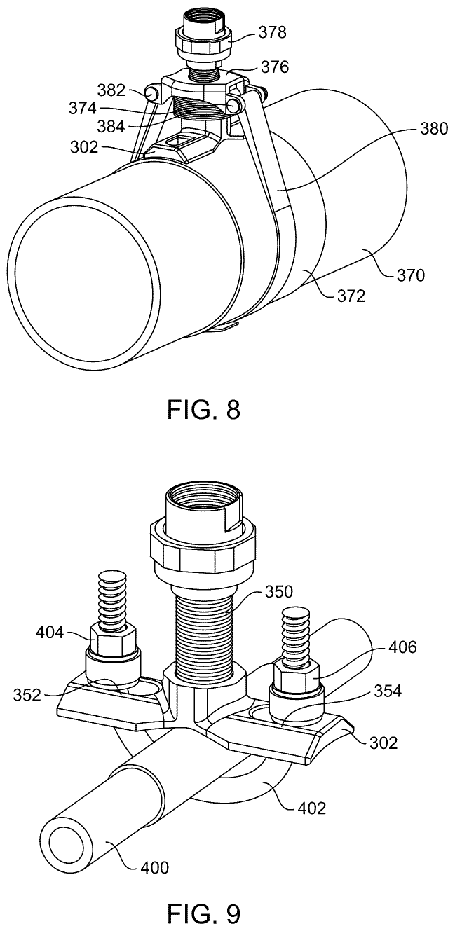

FIGS. 5 and 6 are top plan and front elevation views, respectively, of a clamping foot for smaller pipe diameters in accordance with an embodiment of the present invention. Clamping foot 302 bears some similarities to clamping foot 102 (shown in FIGS. 3 and 4) and like components are numbered similarly. Clamping foot 302 is generally rectangularly shaped having first side 320 that is longer than a second side 322. The longer side 320 is generally aligned with an axis of a larger diameter process fluid conduit, as shown in FIG. 8. Clamping foot 302 also includes an internally threaded central aperture 324 that is configured to receive a union (shown as reference numeral 350 in FIG. 9) that couples to a field device. Central aperture 324 is surrounded by a sidewall 328 that is shaped as a rounded-off hexagon. The hexagonal shape is helpful in that it allows a wrench to grasp the clamping foot when the union 350 and/or field device are being threaded thereto. Sidewall 328 is coupled to foot body 330 at interface 332. In one example, interface 332 is a weld. Clamping foot 302 also includes a pair of reinforcing ribs 334, 336 that extend from sidewall 328 along then length of foot body 330.

Clamping foot 302 differs from clamping foot 102 in a couple of aspects. In a first aspect, a plurality of apertures is provided through clamping foot 302 to directly accept a u-bolt or v-bolt. In the illustrated example, apertures 352, 354 are shown extending through reinforcing ribs 334, 336, respectively. In one particular embodiment, apertures 352, 354 are slots that accommodate a plurality of sizes of u-bolts and v-bolts. In a second aspect, clamping foot 302 includes a transverse v-groove 356. The transverse v-groove 356 provides increased stability to clamping foot 302 when used with smaller pipe diameters, such as that shown in FIG. 9. Clamping foot 302 can be used with larger pipe diameters in a first mode (See FIG. 8) and smaller pipe diameters in a second mode. Accordingly, clamping foot 302 is considered a dual-mode clamping foot.

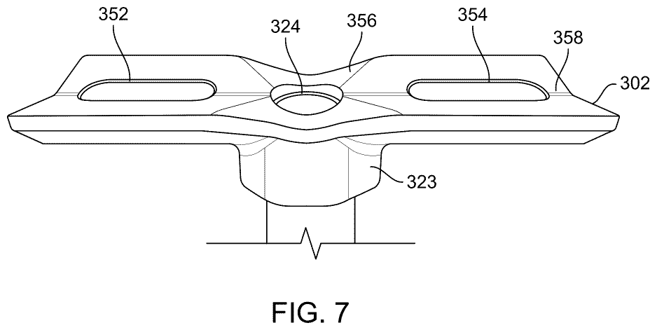

FIG. 7 is a perspective view of a bottom surface of a dual-mode clamping foot in accordance with an embodiment of the present invention. As can be seen in FIG. 7, clamping foot 302 includes a longitudinal v-groove 358 that, in the illustrated embodiment, is centered on apertures 354, 324, and 352. Clamping foot also includes transverse v-groove 356 centered on aperture 324, with portions of transverse v-groove being disposed on opposite sides of aperture 324.

FIG. 8 is a diagrammatic view of a field device mount utilizing a dual-mode clamping foot in a first mode in accordance with an embodiment of the present invention. FIG. 8 shows dual-mode clamping foot 302 functioning in place of clamping foot 102 for a larger diameter (greater than or equal to 2 inches) process fluid conduit 370. In general, an elastomeric of otherwise non-conductive layer 372 is provided around process fluid conduit 370. Then, a union 350 (shown in FIG. 9) is threaded into threaded aperture 324 (shown in FIG. 5) and a biasing member, such as spring 374 is provided about union 350. Cap 376 is placed over biasing member 374 and compressed by rotating mount 378 to lower mount 378 on union 350 until mount 378 bears against cap 376 to such an extent that biasing member 374 is compressed. Then, band 380 is arranged around process fluid conduit 370 and coupled to pins 382, 384 of cap 376. Once band 380 is so coupled, mount 378 is rotated to raise mount 378 on union 350 until mount 378 is no longer in contact with cap 376 (such as shown in FIG. 8). In this state, biasing member 374 exerts a bias force on cap 376 that maintains consistent tension in band 380. Accordingly, clamping foot 302, in its first mode, can function in place of the clamping foot described in the published patent application set forth above.

FIG. 9 is a diagrammatic view of a field device mount utilizing a dual-mode clamping foot in a second mode in accordance with an embodiment of the present invention. In the second mode, clamping foot 302 is rotated 90 degrees relative to the process fluid conduit as compared with the first mode described above with respect to FIG. 8. In the second mode, the process fluid conduit 400 rests in the perpendicular chevron-shaped channel 356. A suitable u-bolt or v-bolt 402 is installed from the underside of the process fluid conduit 400 and passes through apertures 352, 354. Fasteners, such as nuts 404, 406, are attached to the u-bolt or v-bolt 402 and torqued to a suitable torque specification.

Apertures 352, 354 are preferably slots on clamping foot 302 in order to allow for additional methods of assembly other than the u-bolt/v-bolt solution. This allows fasteners such as studs, bolts, or guides to pass through apertures 352, 354 and allow for assembly with the surface, either flat or curved.

Additionally, with the transverse v-groove in clamping foot 302 and apertures 352, 354, a new location is provided for fixturing that can help with preventing assembly movement. Any method of fixturing that interfaces with the chevron slot, channel, or slots could be used as a guide rail, track, pin, block, et cetera. This is particularly useful in applications where users have specific location placements or want to ensure that the assembly is additionally restrained from rotating and is stabilized.

The provision of transverse v-groove 356 provides another feature. Transverse v-groove 356 allows for sensor visualization. The gap created by transverse v-groove 356 relative to the process fluid conduit allows the user to visually see the sensor contact to the surface of the process fluid conduit. Natural light or a flashlight can be used to check for contact and would indicate proper installation of the spring-loaded sensor. This provides the user with additional confidence in the sensing solution.

Although the present invention has been described with reference to preferred embodiments, workers skilled in the art will recognize that changes may be made in form and detail without departing from the spirit and scope of the invention.

What is claimed is:

1. A field device mount comprising:
a union configured to couple to a field device;
a dual-mode clamping foot coupled to the union, the dual-mode clamping foot having a plurality of apertures therethrough and being configured to engage a process fluid conduit; and
wherein the dual-mode clamping foot is configured to engage a larger diameter process fluid conduit in a first mode and is configured to engage a smaller diameter process fluid conduit in a second mode.

2. The field device mount of claim 1, and further comprising:
at least one bolt configured to be disposed around a portion of the process fluid conduit, the at least one bolt having a pair of threaded ends that are configured to pass through respective apertures of the dual-mode clamping foot; and
a pair of fasteners engaged upon the threaded ends of the at least one bolt to force the dual-mode clamping foot into contact with the process fluid conduit.

3. The field device mount of claim 1, wherein the at least one bolt is a u-bolt.

4. The field device mount of claim 1, wherein the at least one bolt is a v-bolt.

5. The field device mount of claim 1, wherein the apertures, of the plurality of apertures, are slots.

6. The field device mount of claim 1, wherein the dual-mode clamping foot has a rectangular foot body with a longer side and a shorter side, and wherein the shorted side is aligned with a longitudinal axis of the process fluid conduit.

7. The field device mount of claim 1, wherein the clamping foot includes a threaded aperture that threadably receives the union.

8. The field device of claim 7, and further comprising a sidewall extending around the threaded aperture, the sidewall being coupled to a clamping foot body at an interface.

9. The field device mount of claim 8, wherein the interface is a weld.

10. The field device mount of claim 8, wherein the clamping foot includes a pair of reinforcing ribs extending from the threaded aperture.

11. The field device mount of claim 1, wherein the clamping foot includes a transverse v-groove.

12. The field device mount of claim 11, wherein the transverse v-groove is configured to contact the process fluid conduit.

13. The field device mount of claim 12, wherein the transverse v-groove includes portions disposed on opposites sides of a threaded aperture that is configured to couple to the union.

14. The field device mount of claim 12, wherein the transverse v-groove is configured to receive additional fixturing to increase stability.

15. The field device mount of claim 14, wherein the additional fixturing includes at least one additional fixture selected from the group consisting of guide rails, tracks, pins, and blocks.

16. The field device mount of claim 14, wherein the transverse v-groove is configured to facilitate visual confirmation of installation.

17. A clamping foot for a field device mount, the clamping foot comprising:
a foot body;
a sidewall attached to the foot body, the sidewall having a threaded aperture therein; and
a plurality of apertures in the foot body, the plurality of apertures being configured to receive at least one bolt.

18. The clamping foot of claim 17, wherein the plurality of apertures are slots.

19. The claming foot of claim 17, and further comprising a pair of reinforcing ribs extending on the foot body away from the threaded aperture.

20. The clamping foot of claim 17, wherein the foot body has a transverse v-groove.

21. The clamping foot of claim 20, wherein portions of the transverse v-groove are disposed on opposite sides of the threaded aperture.

22. The clamping foot of claim 20, wherein the foot body includes a longitudinal v-groove.
